(19) United States
(12) Patent Application Publication
(10) Pub. No.: US 2007/0241208 A1
(43) Pub. Date: Oct. 18, 2007

(54) Spray gun

(76) Inventor: Alfred Gohring, Salem (DE)

Correspondence Address: Pandiscio & Pandiscio, 470 Totten Pond Road, Waltham, MA, 02451-1914, US

(21) Appl. No.: 11/732,930

(22) Filed: Apr. 5, 2007

(30) Foreign Application Priority Data
Apr. 12, 2006 (EP) EP 06007643

(51) Int. Cl. B05B 1/28; A62C 13/62; B05B 9/01

(52) U.S. Cl. 239/296; 239/290; 239/340; 239/526

(57) ABSTRACT

A spray gun (1) for spraying paints and similar viscous media that can be propelled pneumatically, comprising a gun housing (2) for accommodating the components of the spray gun (1) that effect propulsion, mixture and/or metering, a handle (3) projecting from the gun housing (2) and a reservoir tank (5) removably attached to the gun housing (2) for holding the medium to be processed, with the housing (2) of the spray gun (1) provided with an air guidance duct (21) through which the compressed air responsible for atomization flows to an atomizer nozzle (4), whereby surfaces (22) of the air guidance duct (21) and/or atomizer nozzle (4) and/or an air cap (15) which come into contact with the stream of compressed air or are wetted are provided wholly or in part with a structured surface in the form of indentations (51) and/or protrusions (52) worked into the surfaces either successively or with lateral spacings in between them.

The present invention relates to a spray gun for spraying paints and similar viscous media that can be propelled pneumatically, comprising a gun housing for accommodating the components of the spray gun that effect propulsion, mixture and/or metering, a handle projecting from the gun housing and a reservoir tank removably attached to the gun housing for holding the medium to be processed, with the housing of the spray gun provided with an air guidance duct through which the compressed air responsible for atomization flows to an atomizer nozzle.

In disclosed spray guns of this type, the surfaces of the individual components that come into contact with the compressed air responsible for atomization have a smooth configuration so that the friction resistance is kept low. Although these embodiments have proven their effectiveness in practice, it is only possible to increase the atomizer performance by increasing the pumping pressure in this case. Amongst other factors, this demands a considerable amount of construction complexity and involves a permanently increased power consumption, with the effect that the efficiency and economy of a spray gun are unfavorably influenced.

A spray gun of this type for atomizing fluids is disclosed in DE 10 2004 027 551 A1. An atomizer nozzle is arranged in a sleeve. The handle projects from the sleeve. A reservoir tank is removably attached to the sleeve. The air flow required for atomization is generated by an air turbine driven by an electric motor. The components that come into contact with the air flow do not have a structured surface, so as to reduce the flow resistance.

The purpose of the present invention is therefore to create a spray gun using structural methods alone that enables the air speed to be increased and therefore allows and increase in the pumping rate of the medium to be transported. The constructional complexity required in order to achieve this should be kept small whilst retaining the full range of functions, whilst nevertheless allowing a significantly higher quantity of the medium to be transported with the same energy requirement, although at a higher speed.

In accordance with the present invention, this is achieved in a spray gun of the aforementioned type in that the surfaces of the air guidance duct and/or atomizer nozzle and/or an air cap which come into contact with the stream of compressed air or are wetted should be provided wholly or in part with a structured surface in the form of indentations and/or protrusions worked into the surfaces either successively or with lateral spacings in between them.

The projected surfaces of the indentations and/or protrusions can be circular, rectangular, oval, ellipsoid, lens-shaped or polygonal in each case.

Regularly formed indentations and protrusions can be arranged, preferably with an even distribution, on the surfaces that come into contact with the flow of air. However, it is also possible for the surfaces that come into contact with the flow of air to have irregularly formed protrusions and indentations arranged unevenly on them.

The indentations and/or protrusions can also be embodied as scales, preferably overlapping, arranged in the flow direction.

The indentations and/or protrusions should have a lateral extent of 1 to 10 mm and a maximum depth or height of 3 mm.

If the surfaces of a spray gun that come into direct contact with compressed air are configured in accordance with the present invention, it is possible to achieve a significant increase in the pumping speed for the same energy consumption as is required with conventional, smooth contact surfaces, with the effect that the transport rates can be significantly increased without needing to input additional energy. This is because the indentations and/or protrusions provided reduce the air resistance at the surfaces of the components. Depending on the type and arrangement of the indentations and/or protrusions, it is possible to achieve increases of up to 30% in the transport quantities. In this way, the transport quantity of a medium to be processed can be increased significantly without significant constructional complexity and, above all, without requiring the pump unit to draw additional power.

The drawing shows various sample embodiments of a spray gun configured in accordance with the present invention, which are explained in detail below. In the drawing,

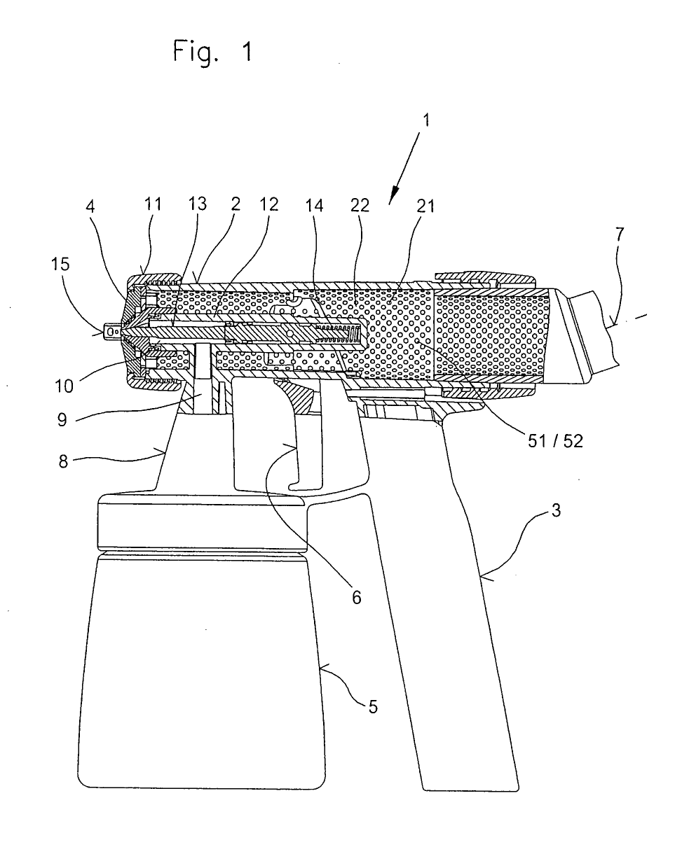

FIG. 1 shows the spray gun with indentations worked into the surface of the air guidance duct,

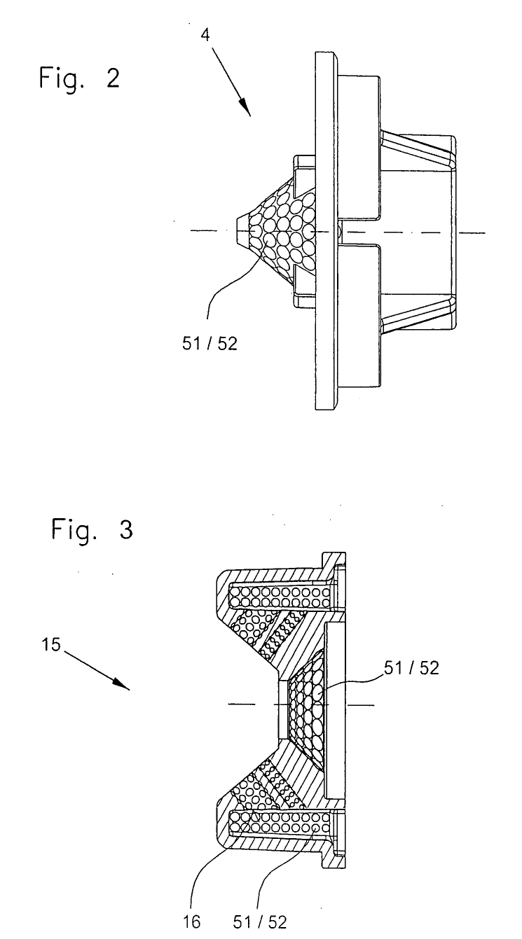

FIGS. 2 and 3 show the atomizer nozzle and air cap of the spray gun in accordance with FIG. 1, in magnified views,

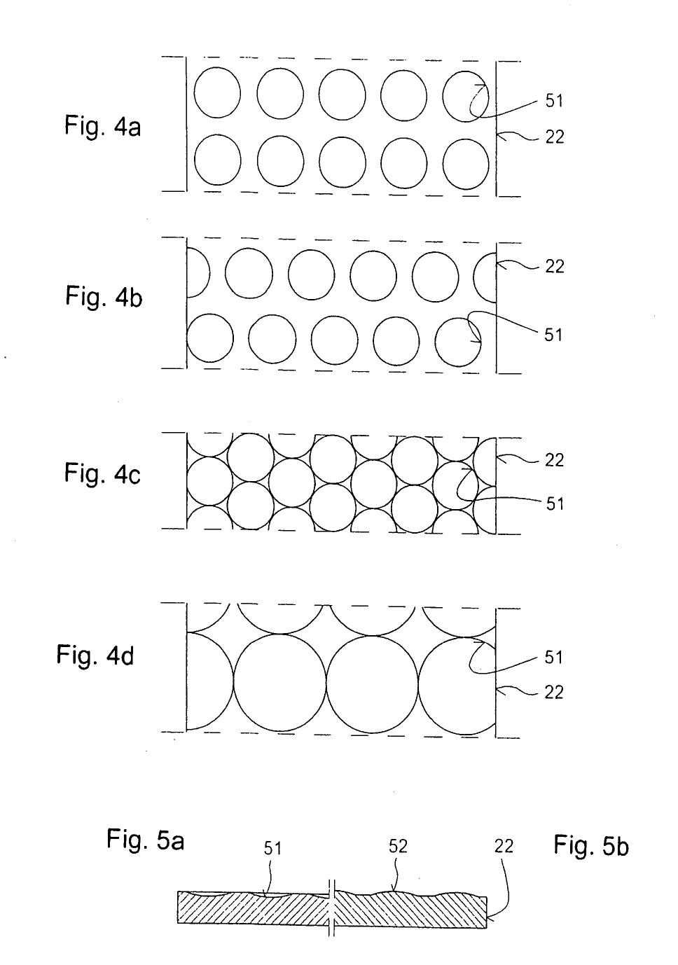

FIGS. 4 to 4d show various arrangements of indentations and/or protrusions as schematic views,

FIGS. 5a and 5b show indentations and protrusions in sectional views,

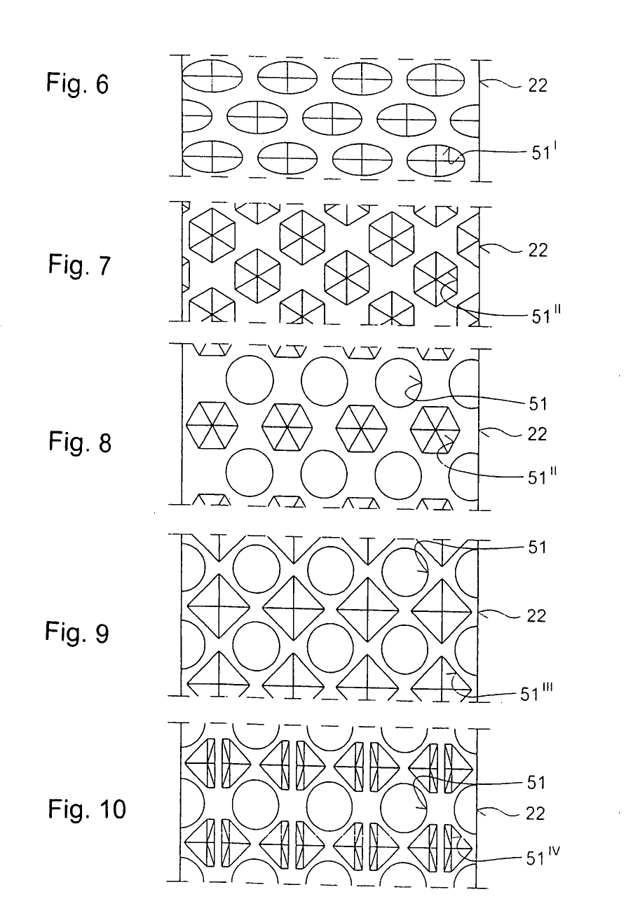

FIGS. 6 to 10 show various embodiments of indentations and/or protrusions in various arrangements and

FIG. 11 shows protrusions embodied as scales.

The spray gun shown in FIG. 1 and identified with 1 is used for spraying paints and similar viscous media and principally consists of a gun housing 2 for accommodating the components that are required for operating the spay gun 1, a handle 3 projecting from the gun housing 2 and a reservoir tank 5 for holding the medium to be processed. An actuating lever 6 in a swiveling mounting is provided in order to trigger a spraying operation which, when it is moved, ejects the medium sucked out of the reservoir tank 5 mixed with air out of an atomizer nozzle 4 by means of compressed air supplied via a pressure line 7.

The reservoir tank 5 in the illustrated embodiment is screwed into a projection 8 that is firmly connected to the gun housing 2 and has a duct 9 worked into it, this duct 9 being connected to the reservoir tank 5 and an annular chamber 10. The annular chamber 10 is created by a sleeve 12 into which a nozzle needle 13 is inserted. The nozzle needle 11 can be moved to the right against the force of a compression spring 14 with the help of the handle 6, with the effect that the compressed air passing through the spray gun 1 sucks the medium to be processed from the reservoir tank 5 and emits it through the atomizer nozzle 4 that is supported against the gun housing 2 and the sleeve 12 by means of a nozzle nut 11.

In order to increase the air speed in the gun housing 2 as well as between the atomizer nozzle 4 and an air cap 15 allocated to the nozzle 4, all of the surfaces of the spray gun 1 that come into contact with the flow of compressed air or are wetted on an air guidance duct 21 provided in the pistol housing 2, therefore its inner jacket surface 22 as well as the atomizer nozzle 4 and the air cap 15—as well as the ducts 16 formed in the air cap 15—are provided with indentations 51 and/or protrusions 52 that can be configured in different ways. The air resistance is thereby decreased with the effect that transport quantities can be increased significantly without additional energy having to be consumed.

FIGS. 4a to 11 present individual schematic views of how the indentations 51 and/or protrusions 52 can be configured.

In accordance with FIG. 4a, the indentations 51 worked into the inner jacket surface 22 have a circular shape in their projected surface and are regularly arranged with a lateral clearance from one another. In FIG. 4b, on the other hand, the indentations 51 are distributed over the inner jacket surface 22 with a lateral offset. The indentations in FIG. 4c are directly adjacent to one another, while in FIG. 4d the indentations 51 have a larger diameter than in the previous embodiments and are arranged in rows.

FIGS. 5a and 5b show sectional views of the gun housing 2, thereby allowing the indentations 51 and protrusions 52 to be recognized as such.

In accordance with FIG. 6, the indentations 51′ can have an oval or elliptical shape, while the projected surface of the indentations 51″ shown in FIG. 7 is hexagonal.

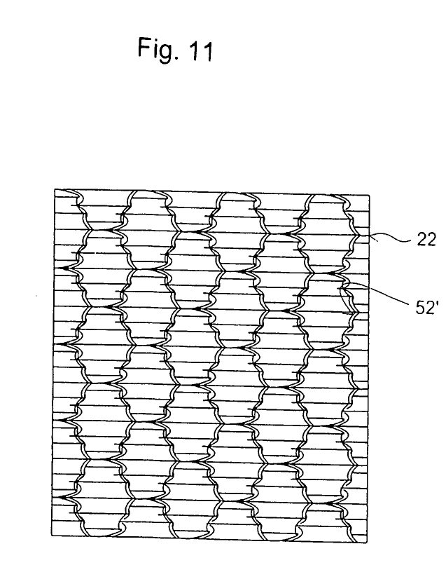

FIG. 8 shows circular indentations 51 and hexagonal indentations 51″ worked into the inner jacket surface 22 at regular intervals from one another, while FIG. 9, on the other hand, shows circular indentations 51 and square indentations 51′″. FIG. 10 shows the arrangement of circular indentations 51 and polygonal indentations 51^{IV} in the inner jacket surface 22.

The inner jacket surface 22 of the air guidance duct 21 of the of the spray gun 1 can however also be configured—as shown in FIG. 11—with protrusions 52′ and/or indentations configured as scales. To a certain extent, the inner jacket surface 22 is therefore covered with a shark skin profile which reduces the flow resistance of the compressed air flow.

1. A spray gun (1) for spraying paints and similar viscous media that can be propelled pneumatically, comprising a gun housing (2) for accommodating the components of the spray gun (1) that effect propulsion, mixture and/or metering, a handle (3) projecting from the gun housing (2) and a reservoir tank (5) removably attached to the gun housing (2) for holding the medium to be processed, with the housing (2) of the spray gun (1) provided with an air guidance duct (21) through which the compressed air responsible for atomization flows to an atomizer nozzle (4), wherein surfaces (22) of at least one of the air guidance duct (21), the atomizer nozzle (4), and an air cap (15), which come into contact with the stream of compressed air, are wetted and are provided at least in part with a structured surface in the form of at least one of indentations (51) and protrusions (52) worked into the surfaces either successively or with lateral spacings therebetween.

2. The spray gun in accordance with claim 1, wherein surfaces of the indentations (51) and protrusions (52) are at least one of circular, rectangular, oval, ellipsoid, lens-shaped and polygonal in configuration.

3. The spray gun in accordance with claim 1, wherein the indentations and protrusions are arranged with an even distributions on the surfaces that come into contact with the flow of air.

4. The spray gun in accordance with claim 1, wherein the surfaces that come into contact with the flow of air have the at least one of irregularly formed protrusions (51^{IV}) and indentations (52″) arranged unevenly therein.

5. The spray gun in accordance with of claims 4, wherein the indentations and protrusions (52′) comprise overlapping scales, arranged in a flow direction.

6. The spray gun in accordance with claims 4, wherein the indentations (51) and protrusions (52) are provided with a lateral extent of 1 to 10 mm and a maximum depth and height of about 3 mm, respectively.
